(19) United States
(12) Patent Application Publication
(10) Pub. No.: US 2008/0228726 A1
(43) Pub. Date: Sep. 18, 2008

(54) Patent searching method and patent searching system using the same

(75) Inventors: Chung-Jen Huang, Kaohsiung (TW); Alex Hrong, Kaohsiung (TW)

Correspondence Address: Joe McKinney Muncy, PO Box 1364, Fairfax, VA, 22038-1364, US

(73) Assignee: Sunonwealth Electric Machine Industry Co., Ltd., Kaohsiung (TW)

(21) Appl. No.: 11/802,370

(22) Filed: May 22, 2007

(30) Foreign Application Priority Data
Mar. 13, 2007 (TW) 096108596

(51) Int. Cl. G06F 17/30

(52) U.S. Cl. 707/3; 707/E17.001

(57) ABSTRACT

A patent searching system includes a patent search interface, at least one patent database system and an executive program. The patent searching system has at least one set of search schedule data provided in the patent database system. The patent searching system is operated to execute the executive program to automatically link to the patent database systems of different official patent offices according to the search schedule data for conducting a patent search. At least one matched patent document of search result is generated according to a user-defined search. The patent searching method applied in the system includes the steps of: providing the search schedule data; executing the executive program to automatically link to the patent database systems of different official patent offices according to the search schedule data for conducting a patent search; and generating patent documents.

### BACKGROUND OF THE INVENTION

1. Field of the Invention

The present invention relates to a patent searching method and a patent searching system using the same. More particularly, the present invention relates to the patent searching method and the patent searching system utilizing a patent search interface with which to arrange a set of search schedule data, and further utilizing an executive program to automatically link to the patent database systems of different official patent offices according to the search schedule data.

2. Description of the Related Art

Currently, most of web sites of the official patent offices (provided with a patent search system) include at least one patent searching web page (i.e. patent database). The patent searching web page provides at least one search column. In conducting a patent search, the user can enter a key word (i.e. user's search term) such as a key word of title, a filing date, a patented date or an applicant such that one or more of computer files of patent documents matching for the user's search term may be generated. In this manner, the user's search can be conducted and at least one patent document of search results may be generated. The computer file of the patent document may include a patent publication document, a patent specification, a patent brief form or other related papers for reference.

The conventional patent searching method requires the user to enter an Internet Protocol address (IP address) of an official patent office into a Uniform Resource Locator (URL) of the World Wide Web (WWW) so as to link to a front page of the official patent office. Once linked, the user can select a hyperlink to further link the patent searching web page (i.e. patent database). By way of example, in searching U.S. patents, the user must enter an IP address of www.uspto.gov/indes.html so as to access the front page of the United State Patent and Trademark Office (USPTO). In the USPTO, the user must select one or a series of hyperlinks (e.g. successively selecting hyperlink of “patents” and hyperlink “search”) so as to access the patent searching web page. The user can enter a keyword into a search field such that a number of U.S. patents matching for the keyword may be obtained. Accordingly, the user can review and download the electronic files of the search results.

However, the conventional patent searching method has several drawbacks or limitations. For example, the user must initially select and link to one of the web sites of the official patent offices, and then actuates several hyperlinks to access the patent searching web page of the selected official patent office. The primary problem with such a patent searching method is due to the fact that the user is subject to limitation in only accessing a single patent searching web page at a time, and requires repeatedly accessing the patent searches in different web pages of different official patent offices for conducting the patent search. In other words, the user cannot synchronously access the different web pages of different official patent offices for conducting the patent search at the same time. Disadvantageously, repeatedly accessing the patent searches in different web pages for conducting the patent search is a waste of searching time or labor cost. Consequently, the conventional patent searching method results in a lower efficiency of patent search.

Another problem with such a patent searching method is due to the fact that the user may not receive new update patents while repeatedly conducting several procedures of the patent search in different web pages of different official patent offices over a long period of time. Another problem with accessing different web pages of different official patent offices is difficulty in operating the different search procedures in the different official patent offices. However, ordinary people are not familiar with the work of patent search in the different official patent offices.

Another problem with such a patent searching method is due to the fact that the keyword entered by the user must compare with all of the patent documents of the patent database system in which some of the matched patent documents are identified in the previous search by using the same keyword. Inevitably, the previously matched patent documents must be repeatedly compared with the user-defined keyword every time as long as the user entering the same keyword in every patent search. Also, the previously matched patent documents must be repeatedly downloaded as long as the user entering the same keyword in every patent search. However, repeatedly downloading the previously downloaded patent documents or comparing the previously matched patent documents with the same keyword in every search is unnecessary and a waste of downloading time or searching time. Consequently, such a patent searching method results in a lower efficiency of patent search.

As is described in greater detail below, the present invention intends to provide a patent searching method and a patent searching system using the same. The patent searching system utilizes a patent search interface with which to arrange a set of search schedule data, and further utilizes an executive program to automatically link to the patent database systems of different official patent offices according to the search schedule data. The patent searching system is successful in synchronously executing the patent search in the different patent database systems of different official patent offices in such a way as to mitigate and overcome the above problem. Furthermore, search results generated by executing the patent searching method are downloaded and stored in a patent database system.

### SUMMARY OF THE INVENTION

The primary objective of this invention is to provide a patent searching method and a patent searching system using the same. The patent searching system utilizes a patent search interface with which to arrange a set of search schedule data, and further utilizes an executive program to automatically link to the patent database systems of different official patent offices according to the search schedule data. Accordingly, the patent searching system is successful in synchronously executing the patent search in the different patent database systems of different official patent offices.

The secondary objective of this invention is to provide the patent searching method and the patent searching system using the same. The patent searching system is operated to execute the executive program, so as to automatically link the patent searching system to the patent database systems of different official patent offices according to the search schedule data within a single procedure of patent search. Accordingly, the patent searching system can reduce the searching time for repeatedly operating several patent searches.

Another objective of this invention is to provide the patent searching method and the patent searching system which requires verifying a number of search results. The patent searching system is designed to compare the search results with previously downloaded patent documents stored in a patent database system. Accordingly, the patent searching system can avoid downloading patent documents already generated in the previous search.

The patent searching system in accordance with an aspect of the present invention includes a patent search interface, at least one patent database system and an executive program. The patent searching system has at least one set of search schedule data provided in the patent database system. The patent searching system is operated to execute the executive program to automatically link to the patent database systems of different official patent offices according to the search schedule data for conducting a patent search. At least one matched patent document of search result is generated according to a user-defined search.

The patent searching method in accordance with an aspect of the present invention includes the steps of: providing the search schedule data; executing the executive program to automatically link to the patent database systems of different official patent offices according to the search schedule data for conducting a patent search; and generating patent documents.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a patent searching system in accordance with a preferred embodiment of the present invention;

FIG. 2 is a schematic view of a search-scheduling window provided in the patent searching system in accordance with the preferred embodiment of the present invention;

FIG. 3 is a schematic view of a condition-setting window provided in the patent searching system in accordance with the preferred embodiment of the present invention;

FIG. 4 is a schematic view of a time-selecting window provided in the patent searching system in accordance with the preferred embodiment of the present invention;

FIG. 5 is a schematic view of a search list generated by the patent searching system in accordance with the preferred embodiment of the present invention;

FIG. 6 is a flow chart of a patent searching method in accordance with a preferred embodiment of the present invention, applied in the patent searching system; and

FIG. 7 is a detailed flow chart of the patent searching method in accordance with the preferred embodiment of the present invention, depicting in FIG. 6.

### DETAILED DESCRIPTION OF THE INVENTION

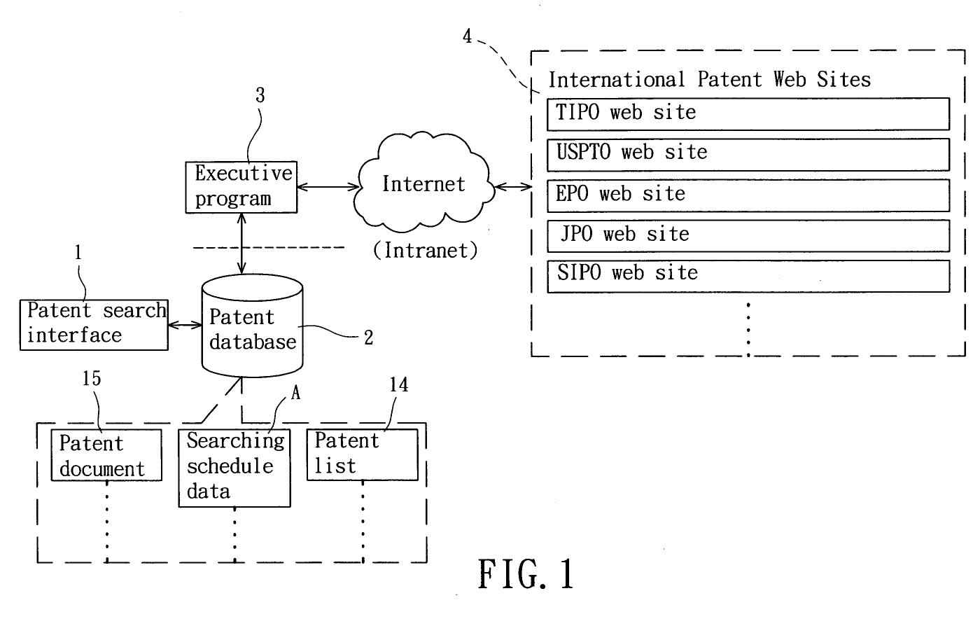

Referring now to FIG. 1, a patent searching system in accordance with a preferred embodiment of the present invention includes a patent search interface 1, at least one patent database system 2 and an executive program 3. Preferably, the patent search interface 1 is operated to link the patent database system 2, and the executive program 3 links to the patent database system 2 via Intranet. A user can access the patent search interface 1 to edit a set of search schedule data (identified as “A”) which is stored in the patent database system 2. Depending on the user-defined search schedule data “A”, the patent search interface 1 is accessed to link at least one patent searching web page 4 of the official patent office. In a preferred embodiment, the patent searching web page 4 may be provided in the Taiwan Intellectual Property Office (TIPO), the United States Patent and Trademark Office (USPTO), the European Patent Office (EPO), the Japan Patent Office (JPO), the State Intellectual Property Office (SIPO) of the People's Republic of China or other official patent offices. The executive program 3 is executed to synchronously conduct a patent search in different official patent offices according to the user-defined search schedule data “A”, and to store patent documents 15 of search results in the patent database system 2.

Turning now to FIGS. 1 through 5, the patent search interface 1 is provided with at least one search-scheduling window 11, at least one condition-setting window 12, at least one time-selecting window 13 and at least one search list 14 for setting and executing the search schedule data

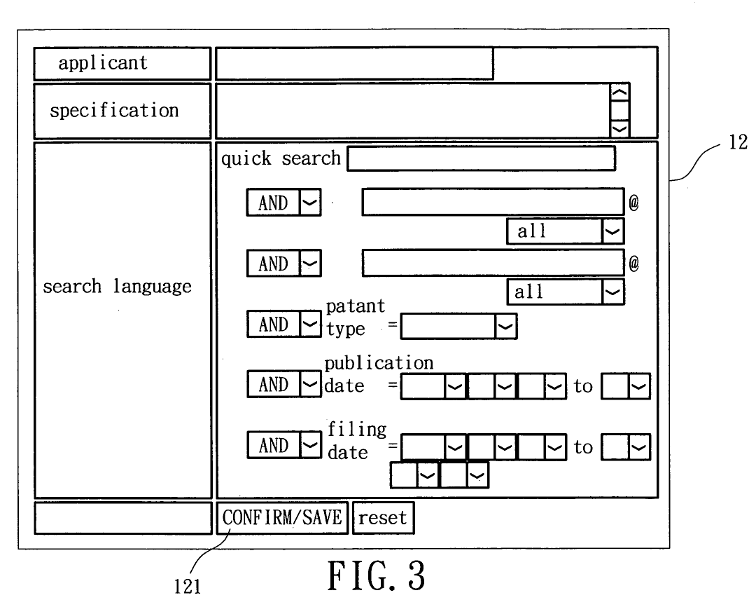

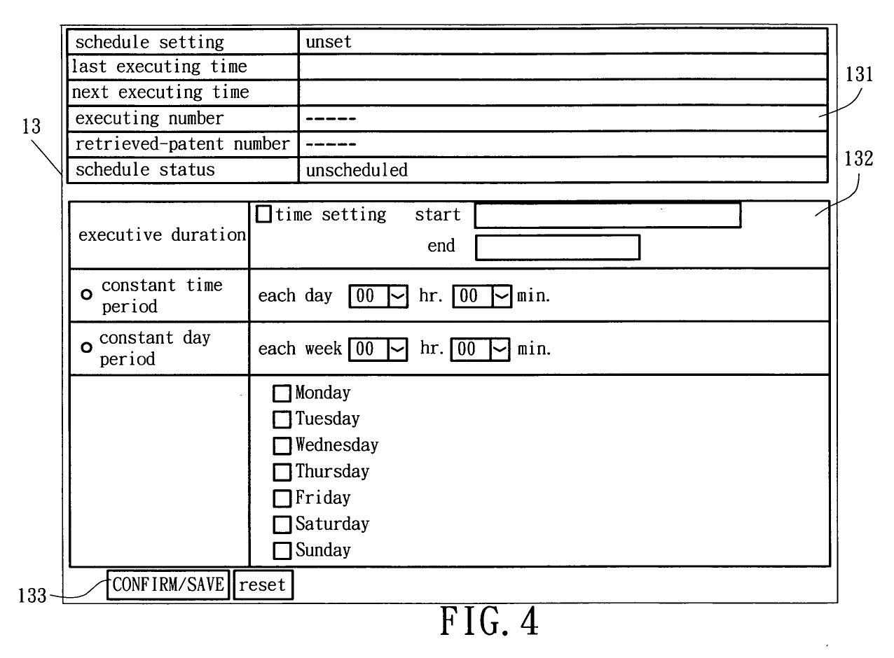

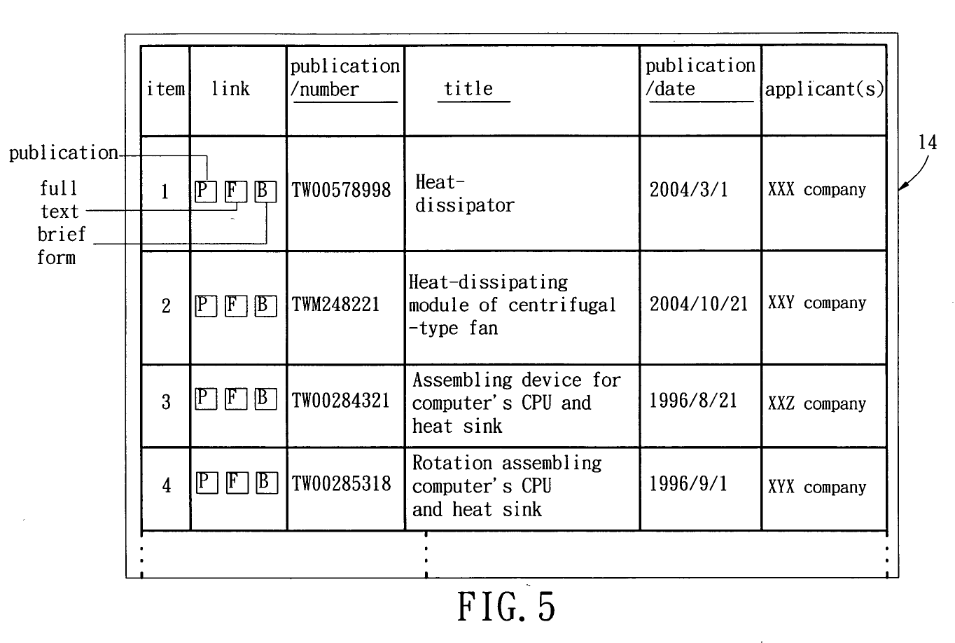

With continued reference to FIGS. 1 through 5, the search-scheduling window 11 includes at least one information list 111, at least one “ADD” key 112, at least one “SET SCHEDULE” key 113, at least one “EDIT” key 114, at least one “DELETE” key 115, at least one “OUTPUT” key 116 and at least one “CORNFIRM” key 117. The information list 111 is used to display the search schedule data “A” which includes an item column, an applicant column, a source column, a status column, a next executing time column and a function key column. The user can select a desired number of the columns of the information list 111. The item column can display a serial number of items of the user-defined search schedule; the applicant column can display applicants of the user-defined search schedule; the source column can display each abbreviation of official patent offices; the status column can display each schedule status of the items of the user-defined search schedule; the next executing time column can display each next executing time of the items of the user-defined search schedule; and the function key column can be used to list the information list 111, “ADD” key 112, “SET SCHEDULE” key 113, “EDIT” key 114, “DELETE” key 115, “OUTPUT” key 116 and “CORNFIRM” key 117. The user can control the “ADD” key 112 to list one or more official patent offices in the search schedule data “A”. By way of example, the official patent offices can be selected from one of TIPO, USPTO, EPO, JPO and SIPO. When the user operates the “SET SCHEDULE” key 113, the condition-setting window 12 of the patent search interface 1 is provided, as best shown in FIG. 3. When the user operates the “EDIT” key 114, the time-selecting window 13 of the patent search interface 1 is provided, as best shown in FIG. 4. The user can control the “DELETE” key 115 to reduce one datum or more data of the search schedule data “A”. After clicking the “OUTPUT” key 116, the patent documents 15 of previous search results stored in the patent database system 2 are generated or the search list 14 of the patent search interface 1 is provided, as best shown in FIG. 5. Accordingly, the user can retrieve one of the patent documents 15 listed in the search list 14 by means of hyperlink. The user can control the “CORNFIRM” key 117 to save the user-defined search schedule data “A” in the patent database system 2.

Still referring to FIG. 3, the condition-setting window 12 of the patent search interface 1 includes at least one search column (unlabelled) in which the user can enter a technical term or a desired keyword (i.e. a piece of undocumented or unstructured information) to determine a user-defined search. The condition-setting window 12 of the patent search interface 1 is available for designated search languages of different official patent offices or several international common languages. By way of example, the condition-setting window 12 of the patent search interface 1 is designed for accessing the patent searching web page of TIPO in which the user can selectively conduct keyword search or Boolean search. The executive program 3 can automatically convert the user-defined technical term into a particular search language of the designated official patent office. The condition-setting window 12 further includes a “CONFIRM/SAVE” key 121. After setting the condition-setting window 12, the user can click the “CONFIRM/SAVE” key 121 to link to the search-scheduling window 11.

Referring again to FIGS. 1 and 4, the time-selecting window 13 includes a schedule list 131, a schedule-setting table 132 and a “CONFIRM/SAVE” key 133. The schedule list 131 preferably includes a schedule-setting column, a last executing time column, a next executing time column, an executing number column, a retrieved-patent number column and a schedule status column. The user can select a desired number of columns from the schedule list 131. The user can examine the completeness of setting a time interval of the search schedule data “A” via the schedule-setting column; review the last and next executing time of the search schedule data “A” via the last and next executing time columns; review the number of executing search by the search schedule data “A” via the retrieved-patent number column; and review retrieved patents of search results via the retrieved-patent number column. The schedule status column is used to display the completeness of setting the search schedule data “A”. The user can set the search time of the search schedule data “A” via the schedule-setting table 132. The schedule-setting table 132 includes an executive duration column, a constant time period column and a constant day period column. The user can set a section of time for executing the search schedule data “A” via the executive duration column, a period of time for repeatedly executing the search schedule data “A” via the constant time period column; and a set of days for repeatedly executing the search schedule data “A” via the constant day period column. After setting the time-selecting window 13, the user can click the “CONFIRM/SAVE” key 133 to link to the search-scheduling window 11.

Referring again to FIGS. 1 and 5, the search list 14 is used to list a number of the patent documents 15 generated by executing the search schedule data “A”. In a preferred embodiment, the patent documents 15 are automatically or manually stored in the patent database system 2, and are classified by a patent analysis system (not shown) prior to storing in the patent database system 2. Preferably, the search list 14 is also stored in the patent database system 2 which includes a plurality of patent information columns and a plurality of data link columns. The patent information column may be in the form of at least one of item column, published/publication column, title column, issue/publication date column and applicant column. The user can operate the data link column to link one computer file of the full-text specification, the publication gazette and the patent brief form of the selected patent document 15. It will be understood that the contents of the patent documents 15 are simplified to construct the patent brief forms by analysis computer programs operated by well-experienced staffs.

Referring back to FIG. 1, the search schedule data “A”, the patent documents 15 of search results or the search lists 14 may be stored in the patent database system 2. The executive program 3 includes at least one URL command, at least one data retrieve command, at least one patent compare command and other related executive commands. The URL command can be set to link several paths of patent searching web pages (or patent database system) provide in different official patent offices. The path is selected from a path of Uniform Resource Location of World Wide Web. For instance, the path of the front page of USPTO is www.uspto.pgov/indes.html or www.uspto.gov/patft/indes.html. The executive program 3 can be executed to retrieve the search schedule data “A” stored in the patent database system 2, so as to link and access the patent searching web pages (or patent database system) provide in the official patent offices according to the URL commands. Once linked, the data retrieve command can be executed to conduct a patent search according to search conditions preset in the search schedule data “A”. Furthermore, the data retrieve command can be executed to convert the search conditions of the search schedule data “A” into the corresponding search languages of different official patent offices such that the executive program 3 can carry out an automatic patent search in the accessed patent searching web page. Consequently, the patent documents 15 matching for the patent search of the search schedule data “A” are generated. In this circumstance, the patent compare command can be executed to compare the patent documents 15 of search results with those of the previously downloaded patent documents 15. The qualified patent documents 15, which are different from the previously downloaded patent documents 15, will be downloaded and stored in the patent database system 2 and will be listed in the search list 14.

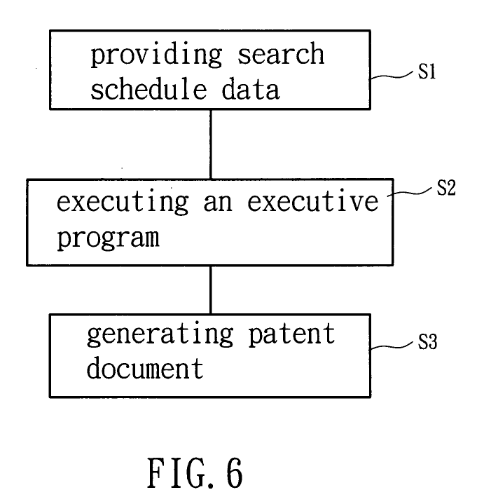

Turning now to FIGS. 1 and 6, a patent searching method in accordance with a preferred embodiment of the present invention includes the steps of: providing a set of search schedule data designated as step “S1”; executing an executive program designated as step “S2”; generating patent documents of search results designated as step “S3”. In step “S1”, the user can initially provide a set of the search schedule data “A” which is stored in the patent database system 2. In step “S2”, the executive program is executed to retrieve the search schedule data “A” from the patent database system 2, thereby linking at least one of the patent searching web pages provide in different official patent offices for searching the patent documents 15. In step “S3”, the patent documents 15 are generated and listed in the search list 14. Accordingly, the patent searching method is implemented to carry out the patent search.

Referring again to FIGS. 1, 3, 6 and 7, the patent searching method in accordance with the preferred embodiment of the present invention is implemented by executing the first step “S1” of providing a set of the search schedule data “A”. The user can access the patent search interface 1 to enter the search-scheduling window 11 in which to set the search schedule data “A” and to store it in the patent database system 2. Preferably, the user can directly access the patent search interface 1. Alternatively, the user can indirectly access the patent search interface 1 via Local Area Network (LAN), Internet or a mobile communication device such as a mobile phone.

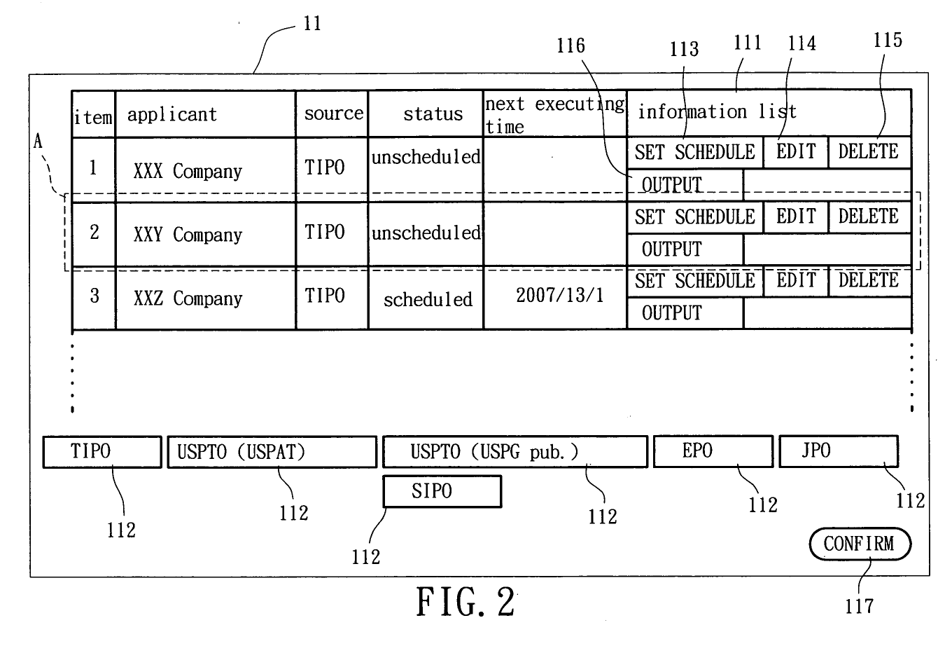

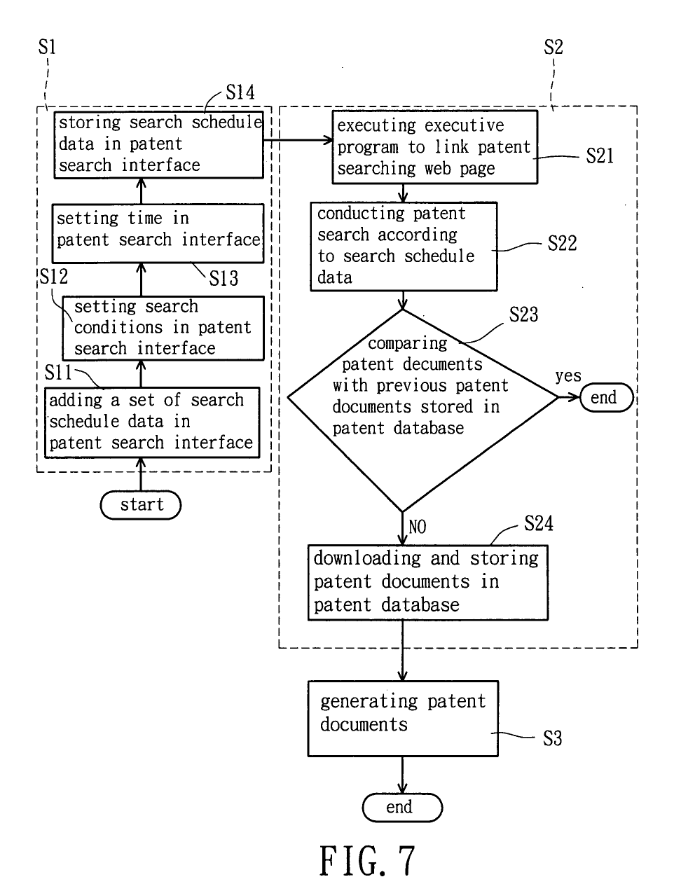

In step “S1”, with continued reference to FIGS. 2 and 7, the user can utilize a tool such as a mouse, a keyboard or a touch panel to actuate the “ADD” key 112 for setting the search schedule data “A”. By way of example, the user can actuate the “ADD” key 112 of TIPO to link the search-scheduling window 11 and enter “XXY Company” in the applicant column for conducting a patent search in Taiwanese patents (identified as S11 in FIG. 7). In this manner, the status column of the search-scheduling window 11 shows the schedule status of “unscheduled”. With continued reference to FIGS. 2, 3 and 7, the user can actuate the “SET SCHEDULE” key 113 to link the condition-setting window 12 and enter search conditions (e.g. “XXY Company”) therein. The user can select the search languages for conducting patent search in the condition-setting window 12 (identified as S12 in FIG. 7). The user can actuate the “CONFIRM/SAVE” key 121 to terminate the time-setting operation and to return to the search-scheduling window 11. With continued reference to FIGS. 2, 4 and 7, the user can actuate the “EDIT” key 114 to link the time-selecting window 13 and to select one executing type of the executive duration column, the constant time period column and the constant day period column (identified as S13 in FIG. 7). The user can actuate the “CONFIRM/SAVE” key 133 to terminate the time-setting operation and to return to the search-scheduling window 11. After adding the search schedule data “A” and setting the search conditions and the search time, the user can actuate the “CONFIRM” key 117 in the search-scheduling window 11 so as to save the search schedule data “A” in the designated patent database system 2 (identified as S14 in FIG. 7).

Referring again to FIGS. 1, 3, 6 and 7, the patent searching method in accordance with the preferred embodiment of the present invention is implemented by executing the second step “S2” of executing an executive program. In step “S2”, the executive program 3 is executed to retrieve the search schedule data “A” stored in the designated patent database system 2, as described in previous step “S1”. Furthermore, the executive program 3 is executed to automatically link to the patent searching web pages (or patent database systems) 4 of the official patent offices according to the search schedule data “A” for conducting a patent search. By way of example, the URL command of the executive program 3 can be executed to link to the patent searching web page 4 of TIPO which is listed in the search schedule data “A” (identified as S21 in FIG. 7). Next, the data retrieve command of the executive program 3 can be executed to conduct a patent search in the patent searching web page 4 by converting the search condition set in the search schedule data “A” into the search language built in the associated patent searching web site 4 (identified as S22 in FIG. 7). For example, the search condition(s) may be in the form of applicant as “XXY Company”. Accordingly, a number of the patent documents 15 matching for the search condition(s) are generated. In a preferred embodiment, the patent compare command of the executive program 3 can be executed to compare each of the current patent documents 15 with the previous downloaded patent documents. The patent documents 15 will be omitted and the patent search will be terminated if all of them have already existed in the patent database system 2 (identified as S23 in FIG. 7). Alternatively, some of the patent documents 15 will be downloaded and stored in the designated patent database system 2 if verified (identified as S24 in FIG. 7). Preferably, executing the executive program 3 can automatically list the patent documents 15 in the search list 14 for reference.

Still referring to FIGS. 1, 3 and 5 through 7, the patent searching method in accordance with the preferred embodiment of the present invention is implemented by executing the third step “S3” of generating patent documents of search results. In step “S3”, the user can select one or more of the “OUTPUT” keys 116 in the search-scheduling window 11 to generate the patent documents 15 or the search list 14 of search results corresponding to the designated search schedule data “A”. Consequently, the patent search interface 1 can preferably display the patent documents 15 of search results in the search list 14, as best shown in FIG. 5. In an alternative embodiment, the patent search interface 1 can directly display or output the patent documents 15 of search results by omitting the search list 14 for the sake of simplicity. The user can review the patent documents 15 listed in the search list 14 and select one of the full-text specification, the publication gazette and the patent brief form of the patent documents 15. Preferably, the patent search interface 1 is further provided with an output interface (not shown) which links to the patent database system 2 for retrieving the downloaded patent documents 15.

As has been discussed above, the conventional searching method requires repeatedly accessing the patent searches in different web pages for conducting the patent search that is a waste of searching time or labor cost. Further, the conventional searching method cannot receive new update patents while repeatedly conducting several procedures of the patent search in different web pages of different official patent offices over a long period of time. Yet further, the conventional searching method requires accessing different web pages of different official patent offices that is difficulty in operating the different search procedures in the different official patent offices for ordinary users. In addition, the conventional searching method results in the fact that the previously matched patent documents must be repeatedly downloaded as long as the user entering the same keyword in every patent search.

In view of the above, the patent searching system in accordance with the present invention utilizes the patent search interface 1 provided with the search schedule data “A”, and the executive program 3 being executed according to the search schedule data “A”. Correspondingly, the patent searching method applied in the patent searching system in accordance with the present invention includes the step “S1” of providing a set of the search schedule data “A”, and the step “S2” of executing the executive program 3 to automatically link to the patent database systems of different official patent offices according to the search schedule data “A” for conducting a patent search. Furthermore, the patent searching method includes the step of comparing each of the matched patent documents 15 with the previously downloaded patent documents. Advantageously, the patent searching system and the patent searching method of the present invention are successful in synchronously executing the patent search in the different patent database systems of different official patent within a single procedure of patent search, and can reduce the searching time for repeatedly operating several patent searches or repeatedly downloading the previously downloaded patent documents.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A patent searching method, comprising the steps of:
providing a set of search schedule data via a patent search interface and storing the search schedule data in a predetermined patent database system; and
executing an executive program to automatically link to at least one designated patent database system according to the search schedule data for conducting a patent search, by converting the search schedule data into a search language used in the designated patent database system, so as to search at least one patent document matching for a user-defined search.

2. The patent searching method as defined in claim 1, wherein the search schedule data is used to set patent searching offices, search conditions and search time.

3. The patent searching method as defined in claim 2, wherein the search time is set by selecting at least one of an executive duration column, a constant time period column and a constant day period column provided in a schedule-setting table of a time-selecting window.

4. The patent searching method as defined in claim 1, further comprising the step of storing the matched patent documents of search results in the predetermined patent database system and providing the matched patent documents.

5. The patent searching method as defined in claim 4, wherein each of the matched patent documents is compared with previously downloaded patent documents.

6. The patent searching method as defined in claim 5, wherein the patent search interface is accessed to link the predetermined patent database system for downloading the patent documents of the search results after comparing with previously downloaded patent documents.

7. The patent searching method as defined in claim 1, wherein a path of Uniform Resource Location of World Wide Web is set in the executive program to automatically link the designated patent database system.

8. The patent searching method as defined in claim 1, wherein a search list is provided in the designated patent database system, the search list including at least one patent information column and at least one data link column to list the patent document.

9. The patent searching method as defined in claim 1, wherein the patent search interface is accessed via Local Area Network, Internet or a mobile communication device.

10. A patent searching system, comprising:
a patent search interface being accessed to set at least one set of search schedule data;
at least one predetermined patent database system linked to the patent search interface so as to store the search schedule data therein; and
an executive program being executed to link to the predetermined patent database system for retrieving the search schedule data, and to automatically link to at least one designated patent database system according to the search schedule data for conducting a patent search, by converting the search schedule data into a search language used in the designated patent database system.

11. The patent searching system as defined in claim 10, wherein a search list is provided in the designated patent database system, the search list including at least one patent information column and at least one data link column to list the patent document.

12. The patent searching system as defined in claim 11, wherein the patent information column is in the form of at least one of item column, published/publication column, title column, issue/publication date column and applicant column.

13. The patent searching system as defined in claim 10, wherein a path of Uniform Resource Location of World Wide Web is set in the executive program to automatically link the designated patent database system.

14. The patent searching system as defined in claim 10, wherein the patent search interface is provided with at least one search-scheduling window, at least one condition-setting window and at least one time-selecting window for setting the search schedule data.

15. The patent searching system as defined in claim 14, wherein the condition-setting window is available for designated search languages of different official patent offices or several international common languages.

16. The patent searching system as defined in claim 14, wherein the time-selecting window includes a schedule list, a schedule-setting table and a “CONFIRM/SAVE” key.

17. The patent searching system as defined in claim 16, wherein the schedule list includes a schedule-setting column, a last executing time column, a next executing time column, an executing number column, a retrieved-patent number column and a schedule status column.

18. The patent searching system as defined in claim 16, wherein the schedule-setting table includes an executive duration column, a constant time period column and a constant day period column.

19. The patent searching system as defined in claim 14, wherein the search-scheduling window includes at least one information list, at least one “ADD” key, at least one “SET SCHEDULE” key, at least one “EDIT” key, at least one “DELETE” key, at least one “OUTPUT” key and one “CORNFIRM” key.

20. The patent searching system as defined in claim 19, wherein the information list includes an item column, an applicant column, a source column, a status column, a next executing time column and a function key column.
